(19) United States
(12) Patent Application Publication
(10) Pub. No.: US 2026/0200749 A1
(43) Pub. Date: Jul. 16, 2026

(54) METHOD FOR PRODUCING HIGH-PURITY MAGNESIUM OXIDE FROM WASTE REFRACTORY MATERIAL THROUGH ECO-FRIENDLY HYDROMETALLURGICAL APPLICATION PROCESS AND MAGNESIUM OXIDE PRODUCED THEREBY

(71) Applicant: Korea Institute Of Geoscience And Mineral Resources, Daejeon (KR)

(72) Inventors: Shun Myung SHIN, Daejeon (KR); Dongju SHIN, Daejeon (KR); Yongyeon JOO, Daejeon (KR); Dongseok LEE, Daejeon (KR)

(73) Assignee: Korea Institute Of Geoscience And Mineral Resources, Daejeon (KR)

(21) Appl. No.: 19/150,420

(22) PCT Filed: Jan. 31, 2024
(86) PCT No.: PCT/KR2024/001447

§ 371 Date: Jul. 23, 2025

(30) Foreign Application Priority Data
Feb. 6, 2023 (KR) 10-2023-0015802

(51) Int. Cl. C01F 5/06; C01F 5/04; C22B 3/08; C22B 26/22

(52) U.S. Cl. CPC C01F 5/06; C01F 5/04; C22B 3/08; C22B 26/22

(57) ABSTRACT

The present invention relates to a method for producing high-purity magnesium oxide from a waste refractory material through an eco-friendly hydrometallurgical application process and magnesium oxide produced thereby, wherein the method comprises: a step of subjecting a magnesium-containing waste refractory material to leaching, and separating a leachate and residues through solid-liquid separation (S10); an impurity purification and leaching step for the leachate (S20); a step of powdering the leachate subjected to the impurity purification and leaching step to prepare a magnesium-containing powder (S30); a step of heat-treating the magnesium-containing powder to prepare magnesium oxide (S40); and a step of washing the heat-treated magnesium oxide to obtain high-purity magnesium oxide (S50).

### TECHNICAL FIELD

The present disclosure relates to a method for producing high-purity magnesium oxide from a waste refractory material through an eco-friendly hydrometallurgical application process and magnesium oxide produced thereby. In particular, the present disclosure relates to a method for eco-friendly production of high-purity magnesium oxide (MgO) through processes such as leaching, purification, and washing using waste refractory materials, which are conventionally recycled as secondary resources or subjected to landfill disposal.

### BACKGROUND ART

Magnesium oxide, commonly referred to as magnesia, is an oxide form of magnesium characterized by a high melting point and hygroscopicity.

The magnesium oxide is mostly produced from the naturally occurring carbonate mineral, magnesite. Magnesia can be classified according to the calcination temperature or the raw materials used. Light-burned magnesia is produced by calcining magnesite at temperatures ranging from 600° C. to 1400° C., while medium-burned magnesia is manufactured at 1400° C. to 2200° C. In addition, fused magnesia is obtained by melting magnesite at temperatures above 2800° C. Seawater magnesia, on the other hand, is produced through precipitation and firing from seawater.

Magnesium oxide produced at high temperatures is used as a raw material for refractory applications. Approximately 70% of the manufactured magnesium oxide is used in refractory materials, and the remaining 30% is utilized across various industries such as agriculture, medicine, optics, nuclear reactors, and rocket propellants, depending on its type.

In Korea's steel industry, MgO—C-containing refractories are used in converters and steel ladles. After use, these refractory materials are mostly discarded, with some partially reused.

Recycling methods include hydrometallurgical approaches, which control nitrogen and aluminum content in the waste refractories and increase the MgO purity through physical separation processes. Alternatively, pyrometallurgical methods combust and vaporize carbon to enhance MgO purity.

However, these methods typically yield MgO of less than 97% purity and are focused on reusing waste refractories as refractory materials. It has rarely been reported a process for producing high-purity MgO from waste refractories.

In Korea, a single domestic smelting company produces magnesium oxide with a purity above 98% via a hydrometallurgical process using seawater, but this production is limited to internal use.

Korea has no domestic magnesium ore resources, thus relies entirely on imports of MgO, resulting in a supply shortage. Therefore, developing a process to recover MgO from waste refractories is urgently needed, along with the establishment of a hydrometallurgical process capable of producing high-purity MgO in an environmentally friendly and economically feasible manner.

In general, a major drawback of eco-friendly smelting processes lies in the high cost of chemical reagents and equipment required, making them economically less viable compared to conventional commercialized methods. Consequently, research is needed to develop a process that applies existing commercial techniques to reduce process complexity and produce high-purity MgO in an eco-friendly manner.

### DISCLOSURE

### Technical Problem

In order to solve the aforementioned problems, the purpose of the present disclosure is to provide an eco-friendly method for producing high-purity magnesium oxide (MgO) from waste refractory materials through a simplified process using an eco-friendly hydrometallurgical application process, thereby offering an alternative to the fully imported MgO currently used in Korea.

The problems to be solved by the present disclosure are not limited to those mentioned above, and other issues not explicitly stated will be clearly understood by those skilled in the art from the following description.

### Technical Solution

In order to achieve the purpose, an aspect of the present disclosure provides a method for producing high-purity magnesium oxide from a waste refractory material through an eco-friendly hydrometallurgical application process. The method comprises:
a step (S10) of subjecting a magnesium-containing waste refractory material to leaching and separating a leachate and residues through solid-liquid separation;
a step (S20) of impurity purification and leaching of the leachate;
a step (S30) of powdering the leachate subjected to the impurity purification and leaching step to prepare a magnesium-containing powder;
a step (S40) of heat-treating the magnesium-containing powder to prepare magnesium oxide; and
a step (S50) of washing the heat-treated magnesium oxide to obtain high-purity magnesium oxide.

In some exemplary embodiments, the magnesium-containing waste refractory material may contain magnesium in an amount ranging from 30 wt % to 55 wt %.

In some exemplary embodiments, the method may further comprise: prior to step (S10) of subjecting a magnesium-containing waste refractory material to leaching and separating a leachate and residues through solid-liquid separation, a step of crushing or grinding the magnesium-containing waste refractory material.

In some exemplary embodiments, the crushed or ground magnesium-containing waste refractory material may have an average particle size of 100 mesh or less.

In some exemplary embodiments, in step (S10), the magnesium-containing waste refractory material may be leached using a sulfuric acid solution having a molar concentration ranging from 1 M to 7 M.

In some exemplary embodiments, step (S10) may be performed under conditions in which:
a solid (g) to liquid (mL) ratio of the magnesium-containing waste refractory material to the sulfuric acid solution is from 1/10 to 3/10;
a reaction temperature is 100° C. or lower; and
a stirring speed is from 100 to 400 RPM.

In some exemplary embodiments, in step (S20), the leachate obtained in step S10 may be used as a leaching agent, and the leaching may be carried out by introducing the magnesium-containing waste refractory material into the leaching agent, followed by separating the resulting leachate and residues.

In some exemplary embodiments, in step (S20), a process may be repeatedly performed in which a preceding-stage leachate is used as a leaching agent, the magnesium-containing waste refractory material is introduced into the leaching agent for leaching, and a subsequent-stage leachate and residues are separated.

In some exemplary embodiments, step (S20) may be performed under conditions in which:
a solid (g) to liquid (mL) ratio of the magnesium-containing waste refractory material to the leaching agent is from 5 to 30;
a reaction temperature is 100° C. or lower; and
a stirring speed is from 100 to 400 RPM.

In some exemplary embodiments, in step (S20), the pH of the leachate subjected to the impurity purification and leaching step may be 7 or higher.

In some exemplary embodiments, step (S30) may be performed for 30 minutes to 2 hours under conditions in which:
a vapor temperature is 45° C. or higher; and
a stirring speed is 25 RPM or higher.

In some exemplary embodiments, in step (S40), the heat treatment may be performed at a temperature of 1000° C. to 1500° C. for 30 minutes to 6 hours.

In some exemplary embodiments, in step (S40), the heat treatment may be performed at a temperature of 1200° C. to 1500° C. for 3 hours to 6 hours.

In some exemplary embodiments, at least one of residues generated in step (S20), a distillate generated in step (S30), exhaust gas components generated in step (S40), or a combination thereof, may be reused in step (S10).

In some exemplary embodiments, in step (S50), the heat-treated magnesium oxide may be washed with distilled water for 5 minutes to 50 minutes, under conditions in which:
a solid (g) to liquid (mL) ratio of the heat-treated magnesium oxide to the distilled water is from 1/1 to 1/10; and
a temperature is from 20° C. to 50° C.

In some exemplary embodiments, step (S50) may be performed once or repeatedly performed 2 to 5 times.

In some exemplary embodiments, in step (S40), the heat treatment may be performed at a temperature of 1200° C. to 1500° C. for 3 hours to 6 hours.

In some exemplary embodiments, step (S50) may be repeatedly performed 2 to 5 times.

In order to achieve the purpose, another aspect of the present disclosure provides a magnesium oxide produced according to the method described above.

### Advantageous Effects

The method for producing high-purity magnesium oxide from a waste refractory material according to the present disclosure enables the environmentally friendly production of high-purity magnesium oxide (MgO), in which impurities such as Fe, Al, Si, and Ca are controlled, by applying an eco-friendly hydrometallurgical application process to waste refractories that have conventionally been either recycled as secondary resources or disposed of by landfilling.

In addition, in the magnesium oxide production method according to the present disclosure, an alkaline solution can be produced from the washing solution used in the purification step for MgO, and sulfur dioxide (SO₂) gas generated during heat treatment can be converted into sulfuric acid through a subsequent catalytic process. Furthermore, the distillate generated during the powdering process can be utilized in sulfuric acid production, thereby effectively reducing wastewater generation. Accordingly, high-purity magnesium oxide can be produced in an environmentally friendly manner by implementing an eco-friendly hydrometallurgical application process.

### DESCRIPTION OF DRAWINGS

FIG. 1 is a process flow chart illustrating a method for producing high-purity magnesium oxide from a waste refractory material through a hydrometallurgical separation and purification process according to an exemplary embodiment of the present disclosure.

FIG. 2 is an X-ray Diffraction (XRD) pattern of the magnesium-containing powder according to an exemplary embodiment of the present disclosure.

FIG. 3 is an XRD pattern of the magnesium oxide recovered after heat treatment according to an exemplary embodiment of the present disclosure.

FIG. 4 is an XRD pattern of the high-purity magnesium oxide recovered after washing according to an exemplary embodiment of the present disclosure.

### BEST MODE

In order to solve the aforementioned problems, the purpose of the present disclosure is to provide an eco-friendly method for producing high-purity magnesium oxide (MgO) from waste refractory materials s through a simplified process using an eco-friendly hydrometallurgical application process, thereby offering an alternative to the fully imported MgO currently used in Korea.

### MODE FOR INVENTION

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in more detail.

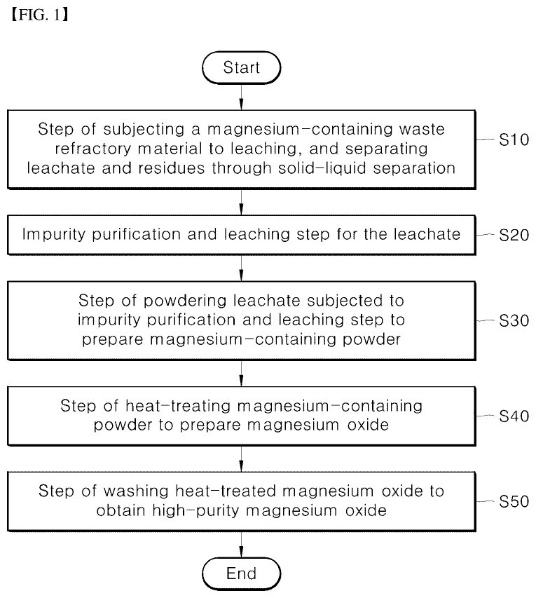

According to the present disclosure, as shown in the process flow chart of FIG. 1, there is provided a method for producing high-purity magnesium oxide from a waste refractory material through an eco-friendly hydrometallurgical application process is provided, the method comprising: a step (S10) of leaching a magnesium-containing waste refractory material and separating a leachate and residues through solid-liquid separation; a step (S20) of impurity purification and leaching of the leachate; a step (S30) of powdering the leachate subjected to the impurity purification and leaching step to produce a magnesium-containing powder; a step (S40) of heat-treating the magnesium-containing powder to produce magnesium oxide; and a step (S50) of washing the heat-treated magnesium oxide to obtain high-purity magnesium oxide.

In an exemplary embodiment of the present disclosure, the magnesium-containing waste refractory material may include at least one selected from the group consisting of dolomitic refractories (MgO—CaO-based refractories), magnesia-carbon refractories (MgO—C-based refractories), magnesia-based refractories (MgO-based refractories), magnesia-chrome refractories (MgO—Cr₂O₃-based refractories), alumina-based refractories, and silica-based refractories, which are capable of withstanding temperatures of 1,500° C. or higher. In a specific example, the magnesium-containing waste refractory material may be an MgO—C waste refractory.

The magnesium-containing waste refractory material may contain magnesium (Mg) in an amount ranging from 30 wt % to 55 wt %, or 35 wt % to 50 wt %, of. In addition to magnesium, the magnesium-containing waste refractory material may further include at least one selected from the group consisting of calcium (Ca), iron (Fe), sodium (Na), potassium (K), aluminum (Al), silicon (Si), and carbon (C).

When the magnesium-containing waste refractory material further includes at least one selected from the group consisting of calcium (Ca), iron (Fe), sodium (Na), potassium (K), aluminum (Al), silicon (Si), and carbon (C), in addition to magnesium, the content of calcium may be from 0.01 wt % to 0.5 wt %, the content of iron may be from 0.01 wt % to 1 wt %, the content of sodium may be from 0.001 wt % to 0.3 wt %, the content of potassium may be from 0.001 wt % to 0.3 wt %, the content of aluminum may be from 0.1 wt % to 5 wt %, the content of silicon may be from 0.01 wt % to 1 wt %, and the content of carbon may be from 1 wt % to 25 wt %.

In an exemplary embodiment of the present disclosure, the method may further comprise a step of crushing or grinding the magnesium-containing waste refractory material, prior to the step of leaching the magnesium-containing waste refractory material and separating a leachate and residues through solid-liquid separation.

The crushing or grinding of the magnesium-containing waste refractory material may be performed using a conventional crusher. For example, the crusher may include at least one selected from the group consisting of a Jaw Crusher, Gyratory Crusher, Roller Crusher, Cone Crusher, Hammermil Crusher, Tumbling Mill, Vibration Mill, Attrition Mill, Ball Mill, Rod Mill, Pebble Mill, and Autogeneous Mill.

The average particle size of the crushed or ground magnesium-containing waste refractory material may be 100 mesh or less, 10 mesh to 100 mesh, or 30 mesh to 100 mesh. When the magnesium-containing waste refractory material is crushed or ground within the above range and subjected to subsequent leaching and extraction processes, the recycling efficiency of the magnesium component contained in the waste refractory material can be improved, and both process time and cost can be reduced.

In an exemplary embodiment of the present disclosure, step (S10) may comprise leaching the magnesium-containing waste refractory material and separating a leachate and residues through solid-liquid separation.

In an exemplary embodiment of the present disclosure, when leaching the magnesium-containing waste refractory material, an acidic solution may be used as a leaching agent. The acidic solution may include at least one selected from the group consisting of nitric acid, hydrochloric acid, sulfuric acid, and perchloric acid. In a specific example, the leaching agent may be a sulfuric acid solution.

In step (S10), the leaching of the magnesium-containing waste refractory material may be performed using a sulfuric acid solution having a molar concentration of 1 M to 7 M, 3 M to 7 M, or 4 M to 6 M. When leaching is carried out using a sulfuric acid solution having a molar concentration within the above ranges, the leaching efficiency of magnesium (Mg) can be increased while simultaneously reducing the co-leaching rates of impurities such as Fe, Al, Ca, and Si.

Step (S10) may be performed under conditions in which the solid (g) to liquid (mL) ratio of the magnesium-containing waste refractory material to the sulfuric acid solution is from 1/10 to 3/10, the reaction temperature is 100° C. or lower, and the stirring speed is from 100 to 400 RPM.

In a specific example, step (S10) may be performed under conditions in which the solid-to-liquid ratio is from 1/10 to 1.5/10, the reaction temperature is from 80° C. to 100° C., and the stirring speed is from 150 to 250 RPM.

In an exemplary embodiment of the present disclosure, the residue separated through solid-liquid separation may contain low-grade valuable metals and carbon (C), and may be utilized as low-grade or medium-grade carbon (C).

In an exemplary embodiment of the present disclosure, step (S20) may be a step for purifying impurities in the leachate separated in step (S10) by a leaching method.

In a specific example, step (S20) may be performed by using the leachate obtained in step (S10) as a leaching agent, introducing the magnesium-containing waste refractory material into the leaching agent to carry out a leaching reaction, and then separating the resulting leachate and residues.

In an exemplary embodiment of the present disclosure, step (S20) may be performed once or repeated 2 to 5 times. In particular, a process may be repeatedly performed in which a preceding-stage leachate is used as a leaching agent, the magnesium-containing waste refractory material is introduced into the leaching agent, and a subsequent-stage leachate and residues are separated.

In one example, when step (S20) is performed once, the first-stage leachate separated in step (S10) may be used as a leaching agent, and the magnesium-containing waste refractory material may be introduced into the first-stage leaching agent, followed by separating a second-stage leachate and residues. The second-stage leachate may then be used in a subsequent extraction process.

In another example, when step (S20) is performed twice, the first-stage leachate separated in step (S10) may be used as a leaching agent, and the magnesium-containing waste refractory material may be introduced into the first-stage leaching agent, followed by separating a second-stage leachate and residues. Subsequently, the second-stage leachate may be used as a leaching agent, and the magnesium-containing waste refractory material may be introduced into the second-stage leaching agent, followed by separating a third-stage leachate and residues. The third-stage leachate may then be used in a subsequent extraction process.

In an exemplary embodiment of the present disclosure, step (S20) may be performed under conditions in which the solid (g) to liquid (L) ratio of the magnesium-containing waste refractory material to the leaching agent is from 5 to 30, the reaction temperature is 100° C. or lower, and the stirring speed is from 100 RPM to 400 RPM, for a duration of 5 minutes to 120 minutes.

In a specific example, step (S20) may be performed under conditions in which the solid-to-liquid ratio is from 7 to 15, the reaction temperature is from 80° C. to 100° C., the stirring speed is from 150 RPM to 250 RPM, and the reaction time is from 30 minutes to 120 minutes.

In an exemplary embodiment of the present disclosure, the pH of the leachate subjected to the impurity purification and leaching step in step (S20) may be 7 or higher, 7 to 10, or 7.7 to 9. When the pH is adjusted within the above range, impurities such as Fe, Al, and Si contained in the leachate separated in step (S10) can be completely precipitated and removed, and the removal rate of Ca can be improved.

In an exemplary embodiment of the present disclosure, after performing the impurity purification and leaching process in step (S20), a high-concentration Mg-containing solution may be obtained in which the concentration of Mg is from 30 g/L to 90 g/L, while impurities such as Fe, Al, and Si are effectively removed.

The leachate and residues separated after the impurity purification and leaching step may be reused, wherein the leachate may be supplied to a subsequent extraction process, and the residues may be reintroduced into the leaching process of step (S10).

In an exemplary embodiment of the present disclosure, step (S30) may be a step of powdering the leachate obtained after the impurity purification and leaching step (S20), which is performed on the leachate separated in step (S10), to prepare a magnesium-containing powder.

The powdering of the magnesium-containing raffinates may be carried out through vacuum distillation or spray drying, and in a specific example, the powdering may be performed by vacuum distillation.

Step (S30) may be performed under conditions in which the vapor temperature is 45° C. or higher, or from 45° C. to 60° C., and the stirring speed is 25 RPM or higher, or from 50 RPM to 110 RPM, for a duration of 30 minutes to 2 hours, or from 1 hour to 1 hour and 30 minutes. Through this process, moisture contained in the leachate can be completely evaporated and dried to obtain a dry powder containing sulfuric acid and magnesium.

The distilled liquid evaporated in step (S30) may be recovered and reused as distilled water for preparing the sulfuric acid solution used in the leaching step (S10).

The obtained magnesium-containing powder may be supplied to the subsequent heat treatment step.

In an exemplary embodiment of the present disclosure, step (S40) may be a step of heat-treating the magnesium-containing powder obtained in step (S30) to produce magnesium oxide (MgO).

The heat treatment in step (S40) may be performed at a temperature of 1000° C. to 1500° C., or 1200° C. to 1500° C., for a duration of 30 minutes to 6 hours, or 3 hours to 6 hours. Through this process, magnesium oxide in powder form can be recovered.

During the heat treatment in step (S40), sulfur dioxide (SO₂)-containing exhaust gas may be generated. The SO₂-containing exhaust gas may be converted into sulfuric acid through a separate catalytic process, and the resulting sulfuric acid may be reused for preparing the sulfuric acid solution used in the leaching step (S10).

In an exemplary embodiment of the present disclosure, step (S50) may be a step of washing the magnesium oxide (MgO) in powder form obtained in step (S40) to increase purity of the magnesium oxide (MgO) powder.

In step (S50), the heat-treated magnesium oxide may be washed with distilled water to remove impurities, particularly calcium (Ca).

Step (S50) may be performed under conditions in which the solid (g) to liquid (mL) ratio of the heat-treated magnesium oxide to the distilled water is from 1/1 to 1/10, 1/2 to 1/10, or 1/2 to 1/3.

Step (S50) may be performed by washing the heat-treated magnesium oxide with distilled water at a temperature of 20° C. to 50° C., or 20° C. to 30° C., for a duration of 5 minutes to 50 minutes, or 20 minutes to 30 minutes.

Step (S50) may be performed once or repeatedly 2 to 5 times. In a specific example, step (S50) may be repeated 2 to 3 times.

After washing, the pH of the MgO may be 10 or higher, 10 to 13, or 10.2 to 12.5.

The washing solution obtained after washing the heat-treated MgO with distilled water in step (S50) may contain calcium (Ca) as an impurity. The washing solution may be left exposed to the atmosphere to remove calcium and may be used to produce an alkaline solution having a pH of 10 or higher.

In an exemplary embodiment of the present disclosure, by adjusting the heat treatment temperature and time in step (S40), and depending on the number of washing cycles and solid-liquid ratio in step (S50), high-purity MgO can be produced while minimizing magnesium loss and enhancing the calcium removal rate.

In a specific example, when the magnesium oxide (MgO) obtained by performing heat treatment in step (S40) at a temperature of 1200° C. to 1500° C. for 3 hours to 6 hours is subjected to 2 to 3 repeated washing cycles using distilled water, the calcium (Ca) removal rate can be improved while minimizing the loss of magnesium (Mg).

In addition, the present disclosure may provide high-purity magnesium oxide produced by the above-described method for producing high-purity magnesium oxide through an eco-friendly hydrometallurgical application process.

As described above, the method for producing high-purity magnesium oxide from a waste refractory material through an eco-friendly hydrometallurgical application process and magnesium oxide produced thereby according to the present disclosure has been described and illustrated in the drawings. However, the descriptions and illustrations provided herein include only the essential components necessary for understanding the present disclosure. In addition to the processes and apparatuses described and illustrated, other processes and apparatuses not explicitly described or illustrated may be appropriately applied and utilized to implement the method and magnesium oxide produced by the method according to the present disclosure.

Hereinafter, exemplary embodiments will be described in detail to specifically explain the present disclosure. However, the exemplary embodiments according to the present disclosure may be modified in various forms, and the scope of the present disclosure should not be construed as being limited to the embodiments described below. The exemplary embodiments of the present disclosure are provided to more fully explain the present disclosure to those of ordinary skill in the art.

### Exemplary Embodiments

Hereinafter, an MgO—C waste refractory material containing valuable metal components in the weight percentages shown in Table 1 was used as a raw material for the magnesium-containing waste refractory.

TABLE 1

| Mg | Ca | Fe | Na | K | Al | Si | C |
|---|---|---|---|---|---|---|---|
| 35-50 | 0.1-0.3 | 0.1-0.5 | 0.01-0.1 | 0.01-0.1 | 0.5-2 | 0.1-0.5 | 10-20 |

### Exemplary Embodiment 1: First-Stage Leaching of MgO—C Waste Refractory

Leaching was performed using sulfuric acid (H₂SO₄) solutions with concentrations of 1 M, 3 M, 5 M, and 7 M as leaching agents, respectively, for MgO—C waste refractory having an average particle size of 60 mesh or less. The solid-to-liquid ratio of the MgO—C waste refractory to the sulfuric acid solution was set to 1/10, and the reaction was carried out at a temperature of 90° C. with a stirring speed of 200 rpm.

Table 2 below shows the composition (mg/L) of the leachate obtained from the 1 M sulfuric acid leaching experiment. As shown in Table 2, approximately 50% of Mg was leached over 120 minutes. In contrast, Ca showed a high initial leaching rate of 95.1%, which gradually decreased to 85.8% by the end of the reaction.

In addition, the leaching rates of Fe, Al, and Si decreased as the pH increased. Fe was no longer leached and instead precipitated after 90 minutes. Al began to precipitate after 15 minutes, and Si started precipitating from 45 minutes. These impurities were effectively removed by precipitation.

When 1 M sulfuric acid was used as the leaching agent, the initial pH was 4.1 and increased to 6.7 after 120 minutes. This pH increase was attributed to the basic nature (alkalinity) of MgO in the waste refractory and the relatively low concentration of the sulfuric acid used.

In conclusion, while impurities such as Fe, Al, and Si were successfully removed in the 1 M sulfuric acid experiment, the leaching rate of Mg was limited to approximately 50%.

TABLE 2

| time (min) | Mg | Ca | Fe | Al | Si | Na | K | pH |
|---|---|---|---|---|---|---|---|---|
| 5 | 49.7 | 95.1 | 60.8 | 0.3 | 11.9 | 40.5 | 59.4 | 4.1 |
| 10 | 53.0 | 96.0 | 52.9 | 0.1 | 7.8 | 44.7 | 59.8 | 4.3 |
| 15 | 50.4 | 87.4 | 42.2 | 0 | 5.2 | 44.7 | 54.7 | 4.6 |
| 30 | 51.1 | 84.6 | 30.6 | 0 | 3.1 | 41.1 | 55.6 | 6.2 |
| 45 | 48.1 | 88.3 | 7.1 | 0 | 0 | 40.5 | 57.7 | 6.4 |
| 60 | 50.5 | 86.1 | 6.8 | 0 | 0 | 41.8 | 56.9 | 6.5 |
| 90 | 49.9 | 86.5 | 0.0 | 0 | 0 | 41.1 | 59.8 | 6.6 |
| 120 | 49.2 | 85.8 | 0.0 | 0 | 0 | 43.1 | 59.4 | 6.7 |

In addition, Table 3 below shows the results of leaching with 3 M sulfuric acid. As shown in Table 3, the leaching rate of Mg increased from an initial 75.5% to 93.7% at 60 minutes over a total duration of 120 minutes. Unlike the 1 M sulfuric acid leaching results, calcium (Ca), iron (Fe), and aluminum (Al) were fully leached under these conditions. This complete leaching of impurities is attributed to the higher concentration of SO₄²⁻ ions and the lower pH in the 3 M sulfuric acid solution.

In other words, when 3 M sulfuric acid was used, the leaching rate of Mg was significantly increased, reaching up to 93.7%; however, impurities such as Ca, Fe, and Al were also completely leached, resulting in a higher concentration of impurities in the leachate compared to the 1 M sulfuric acid leaching. The pH during the leaching process with 3 M sulfuric acid was below 0.1.

TABLE 3

| time (min) | Mg | Ca | Fe | Na | K | Al | Si | pH |
|---|---|---|---|---|---|---|---|---|
| 5 | 75.5 | 100 | 84.6 | 89.2 | 92.0 | 82.9 | 76.7 | 0.1 |
| 10 | 84.9 | 100 | 95.4 | 90.9 | 92.0 | 96.2 | 76.0 | 0.08 |
| 15 | 87.3 | 100 | 98.8 | 88.4 | 86.8 | 100 | 92.5 | 0.06 |
| 30 | 92.7 | 100 | 100 | 86.7 | 85.1 | 100 | 86.3 | 0.04 |
| 45 | 92.7 | 100 | 100 | 87.5 | 88.5 | 100 | 81.5 | 0.03 |
| 60 | 93.7 | 100 | 100 | 91.8 | 85.1 | 100 | 82.1 | 0.01 |
| 90 | 93.7 | 100 | 100 | 93.4 | 97.2 | 100 | 80.7 | 0.00 |
| 120 | 93.7 | 100 | 100 | 90.1 | 86.8 | 100 | 74.8 | 0.03 |

In addition, Table 4 below shows the results of leaching with 5 M sulfuric acid. As shown in Table 4, the leaching rate of Mg increased from an initial 68.9% to 95.8% at 60 minutes over a total duration of 120 minutes. In the case of calcium (Ca), the leaching rate began at 87.1% at 5 minutes, but significantly decreased over time, reaching 36.2% at 120 minutes. This decrease is believed to be due to the relatively high concentration of SO₄²⁻ and low pH in the 5 M sulfuric acid solution in comparison to the 3 M sulfuric acid, which promoted the precipitation of Ca as CaSO₄.

Similarly, silicon (Si) was also precipitated as SiO₂ due to comparable reactions under the same conditions.

In contrast, iron (Fe) and aluminum (Al) were completely leached due to the low pH of the solution. These results indicate that using 5 M sulfuric acid can increase the Mg leaching rate to over 95%, while simultaneously enabling effective control of impurities such as Ca and Si.

TABLE 4

| time (min) | Mg | Ca | Fe | Na | K | Al | Si | pH |
|---|---|---|---|---|---|---|---|---|
| 5 | 68.9 | 87.1 | 76.5 | 81.3 | 72.3 | 68.8 | 30.6 | −0.3 |
| 10 | 90.3 | 39.0 | 100 | 98.5 | 92.4 | 94.7 | 27.1 | −0.6 |
| 15 | 92.7 | 33.0 | 100 | 98.5 | 100.4 | 100 | 31.3 | −0.6 |
| 30 | 94.7 | 34.5 | 100 | 99.4 | 90.4 | 100 | 21.6 | −0.6 |
| 45 | 95.0 | 36.2 | 100 | 96.6 | 94.4 | 100 | 22.3 | −0.6 |
| 60 | 95.8 | 37.1 | 100 | 94.6 | 98.4 | 100 | 19.1 | −0.6 |
| 90 | 95.8 | 37.5 | 100 | 100.4 | 98.4 | 100 | 14.9 | −0.6 |
| 120 | 95.8 | 36.2 | 100 | 99.4 | 100.4 | 100 | 7.5 | −0.6 |

In addition, Table 5 below shows the results of leaching with 7 M sulfuric acid. As shown in Table 5, the leaching rate of Mg increased from an initial 79.9% to 95.8% at 30 minutes, within a total reaction time of 45 minutes. In the case of calcium (Ca), the leaching rate was only 17%, and silicon (Si) was not leached at all.

Compared to the preceding conditions using 3 M and 5 M sulfuric acid, the significantly higher concentration of SO₄²⁻ ions in the 7 M sulfuric acid solution appears to have suppressed the leaching of Ca and Si. On the other hand, the leaching rates of iron (Fe) and aluminum (Al) reached 100% and 98%, respectively, due to the low pH of the solution.

These results demonstrate that increasing the concentration of sulfuric acid not only enhances the leaching rate of Mg but also suppresses the co-leaching of Ca and Si due to the increased concentration of SO₄²⁻ ions.

TABLE 5

| time | | | | | | | | |
|---|---|---|---|---|---|---|---|---|
| (min) | Mg | Ca | Fe | Na | K | Al | Si | pH |
| 5 | 79.9 | 24.4 | 75.2 | 85.2 | 95.4 | 76.6 | 0.0 | −0.886 |
| 10 | 90.2 | 22.7 | 86.1 | 96.1 | 99.1 | 91.1 | 0.0 | −0.844 |
| 15 | 93.3 | 20.4 | 92.8 | 100.0 | 96.3 | 98.6 | 0.0 | −0.863 |
| 30 | 95.8 | 38.9 | 94.1 | 77.7 | 95.4 | 72.6 | 0.0 | −0.841 |
| 45 | 95.8 | 28.1 | 95.6 | 69.8 | 95.2 | 67.5 | 0.0 | −0.791 |
| 60 | 95.8 | 22.4 | 98.8 | 95.6 | 95.4 | 92.3 | 0.0 | −0.933 |
| 90 | 95.8 | 21.5 | 100 | 100.8 | 95.4 | 96.9 | 0.0 | −0.855 |
| 120 | 95.8 | 17.4 | 100 | 99.7 | 94.5 | 98.7 | 0.0 | −0.913 |

### Exemplary Embodiment 2: Impurity Purification Leaching of MgO Waste Refractory

An impurity purification leaching experiment was conducted by reusing the leachates obtained using 3 M, 5 M, and 7 M sulfuric acid solutions as leaching agents.

The 1 M sulfuric acid condition was excluded because the final pH of the leachate obtained with 1 M sulfuric acid was already relatively high (above pH 6.7), and it was anticipated that secondary leaching of Mg would be insignificant under such conditions.

In contrast, the final pH values of the first-stage leachates obtained with 3 M, 5 M, and 7 M sulfuric acid were approximately pH 0.03, pH-0.6, and pH-0.9, respectively. Such pH values were sufficiently low, making them suitable for further leaching of Mg contained in the added waste refractory material.

The composition (mg/L) of the first-stage leachates used as leaching agents in the impurity purification leaching process was measured and is shown in Table 6 below.

TABLE 6

| sulfuric acid | | | | | | | | |
|---|---|---|---|---|---|---|---|---|
| concentration | Mg | Ca | Fe | Na | K | Al | Si | pH |
| 3M | 39400 | 292 | 328 | 10.6 | 5 | 998 | 83.7 | 0.03 |
| 5M | 40300 | 105.7 | 328 | 10.3 | 5 | 998 | 8.4 | −0.6 |
| 7M | 40300 | 50.8 | 328 | 10.1 | 5 | 985 | 0 | −0.9 |

In addition, Table 7 below shows the results of the impurity purification leaching process using the first-stage leachate obtained from 3 M sulfuric acid. During the impurity purification leaching reaction, the temperature was maintained at 90° C., the solid-to-liquid ratio was set to 1/10, and the stirring speed was adjusted to 200 rpm.

As a result, magnesium (Mg) was leached up to a concentration of 45600 mg/L. In contrast, impurities such as iron (Fe), aluminum (Al), and silicon (Si) were completely precipitated and not detected due to the pH rising from the initial value to 8.56. As for calcium (Ca), 342 mg/L remained in the solution at the end of the reaction.

TABLE 7

| time (min) | Mg | Ca | Fe | Na | K | Al | Si | pH |
|---|---|---|---|---|---|---|---|---|
| first-stage | 39400 | 292 | 328 | 10.6 | 5 | 998 | 83.7 | 0.031 |
| leachate | | | | | | | | |
| 5 | 42900 | 300 | 0 | 12.1 | 2.6 | 0 | 181.1 | 8.56 |
| 10 | 43000 | 328 | 0 | 12.5 | 2.4 | 0 | 53 | 8.66 |
| 15 | 45900 | 327 | 0 | 10.5 | 2.5 | 0 | 11 | 8.67 |
| 30 | 45000 | 324 | 0 | 11.5 | 2.6 | 0 | 0 | 8.78 |
| 45 | 45100 | 331 | 0 | 10.6 | 2.4 | 0 | 0 | 8.72 |
| 60 | 45300 | 340 | 0 | 12.6 | 2.8 | 0 | 0 | 8.66 |
| 90 | 45600 | 341 | 0 | 12.2 | 2.8 | 0 | 0 | 8.72 |
| 120 | 45600 | 342 | 0 | 12.3 | 2.9 | 0 | 0 | 8.66 |

In addition, Table 8 below shows the results of the impurity purification leaching process using the first-stage leachate obtained from 5 M sulfuric acid. During the impurity purification leaching reaction, the temperature was maintained at 90° C., the solid-to-liquid ratio was set to 1/10, and the stirring speed was adjusted to 200 rpm.

As a result, magnesium (Mg) was leached up to a concentration of 52600 mg/L. Meanwhile, impurities such as iron (Fe), aluminum (Al), and silicon (Si) gradually decreased and were completely precipitated due to the pH increasing from an initial value of 5.21 to a final value of 7.81; thus, they were not detected in the final solution. In the case of calcium (Ca), 157 mg/L remained in the solution at the end of the reaction.

TABLE 8

| time (min) | Mg | Ca | Fe | Na | K | Al | Si | pH |
|---|---|---|---|---|---|---|---|---|
| first-stage | 40300 | 105.7 | 328 | 10.3 | 5 | 998 | 8.4 | −0.662 |
| leachate | | | | | | | | |
| 5 | 50900 | 188.2 | 120 | 21.5 | 6.1 | 0 | 180.5 | 5.21 |
| 10 | 51000 | 121.2 | 37 | 24.6 | 6 | 0 | 120.2 | 5.81 |
| 15 | 51900 | 144.6 | 11 | 24.8 | 6.3 | 0 | 90.6 | 5.84 |
| 30 | 52000 | 157.6 | 1.2 | 23.6 | 6.1 | 0 | 80.6 | 6.09 |
| 45 | 52100 | 156.6 | 0 | 24.8 | 6.2 | 0 | 79 | 6.56 |
| 60 | 52300 | 155.2 | 0 | 24.5 | 6.3 | 0 | 62 | 6.84 |
| 90 | 52600 | 158.2 | 0 | 24.9 | 6.4 | 0 | 4 | 7.23 |
| 120 | 52600 | 157.5 | 0 | 24.6 | 6.4 | 0 | 0 | 7.81 |

In addition, Table 9 below shows the results of the impurity purification leaching process using the first-stage leachate obtained from 7 M sulfuric acid. During the impurity purification leaching reaction, the temperature was maintained at 90° C., the solid-to-liquid ratio was set to 1/10, and the stirring speed was adjusted to 200 rpm.

As a result, magnesium (Mg) was leached up to a concentration of 51600 mg/L. Unlike the leaching results using 3 M and 5 M sulfuric acid, the pH increased only slightly to −0.1, resulting in the presence of residual impurities in the final solution: 555 mg/L of iron (Fe), 158 mg/L of aluminum (Al), and 37.6 mg/L of silicon (Si). Based on the final pH of −0.1, a second impurity purification leaching experiment was subsequently conducted using this leachate.

TABLE 9

| time (min) | Mg | Ca | Fe | Na | K | Al | Si | pH |
|---|---|---|---|---|---|---|---|---|
| first-stage | 40300 | 50.8 | 328 | 10.1 | 5 | 985 | 0 | |
| leachate | | | | | | | | |
| 5 | 47000 | 276.6 | 512.2 | 15.3 | 3.1 | 126.6 | 35 | −0.83 |
| 10 | 49000 | 243.6 | 510.2 | 25.5 | 6.3 | 154.5 | 34.2 | −0.46 |
| 15 | 51600 | 198 | 499.5 | 25.3 | 6.3 | 153.5 | 35.6 | −0.39 |
| 30 | 51600 | 63.6 | 479.6 | 25.1 | 6.1 | 158.5 | 36.6 | −0.38 |
| 45 | 51600 | 66.2 | 488.5 | 25.4 | 6.3 | 158.4 | 35.5 | −0.39 |
| 60 | 51300 | 67.4 | 515.2 | 25.5 | 6 | 156.5 | 37.4 | −0.28 |
| 90 | 51600 | 72.2 | 546.5 | 25.3 | 6.2 | 158.4 | 37.5 | −0.19 |
| 120 | 51600 | 72.2 | 555.5 | 25.4 | 6.2 | 158.2 | 37.6 | −0.1 |

The results of the impurity purification leaching process using the second-stage leachate obtained from 7 M sulfuric acid are shown in Table 10 below. During the impurity purification leaching reaction, the temperature was maintained at 90° C., the solid-to-liquid ratio was set to 1/10, and the stirring speed was adjusted to 200 rpm.

As a result, magnesium (Mg) was leached up to a concentration of 58300 mg/L. The pH increased to 8.23, leading to the complete precipitation of iron (Fe), aluminum (Al), and silicon (Si), such that none of these elements were detected in the final solution. In the case of sodium (Na), the leaching concentration continuously decreased, which is believed to be due to the precipitation of Na as Na₂SO₄ with increasing pH.

TABLE 10

| time (min) | Mg | Ca | Fe | Na | K | Al | Si | pH |
|---|---|---|---|---|---|---|---|---|
| second-stage | 51600 | 72.5 | 554.1 | 25.5 | 5.9 | 152.1 | 37.1 | −0.1 |
| leachate | | | | | | | | |
| 5 | 57200 | 276.6 | 79.4 | 30.4 | 7.5 | 5.1 | 35 | 6.66 |
| 10 | 57600 | 243.6 | 30.1 | 17.6 | 8.1 | 2 | 6 | 7.37 |
| 15 | 58100 | 298 | 14 | 13.2 | 8.2 | 0 | 2 | 7.65 |
| 30 | 57900 | 173.6 | 1 | 13.5 | 8.2 | 0 | 0 | 7.83 |
| 45 | 58200 | 166.2 | 0 | 13.5 | 8.2 | 0 | 0 | 7.92 |
| 60 | 58100 | 157.4 | 0 | 12.9 | 8.2 | 0 | 0 | 8.02 |
| 90 | 58300 | 142.2 | 0 | 13.5 | 8.2 | 0 | 0 | 8.16 |
| 120 | 58300 | 129.2 | 0 | 13.4 | 8.3 | 0 | 0 | 8.23 |

### Exemplary Embodiment 3: Impurity Purification Leaching Process According to Solid-to-Liquid Ratio Using 5 M Sulfuric Acid Solution

Tables 11 and 12 below show the results of the impurity purification leaching process according to the solid-to-liquid ratio, using the first-stage leachate obtained with 5 M sulfuric acid solution as the leaching agent. During the impurity purification leaching reaction, the temperature was maintained at 90° C., and the stirring speed was adjusted to 200 rpm.

The solid-to-liquid ratio plays a critical role in this process, as it not only affects the leaching efficiency of Mg during the second-stage leaching, but also enhances the concentration of Mg in the solution while simultaneously increasing the pH automatically, thereby allowing control over impurities such as Fe, Al, and Si. The ratio of the input sample is particularly important because the residue generated after the impurity purification leaching can be reused by mixing it with new feedstock during the first-stage leaching, which makes it possible to calculate the required amount of sample to be introduced in the first-stage leaching step.

Table 11 shows the measurement results of the composition (mg/L) of the second-stage leachate in the impurity purification leaching process using a solid-to-liquid ratio of 7.5% (500 mL of solution/37.5 g of sample). In this case, magnesium (Mg) was leached up to 53400 mg/L, and calcium (Ca) was present at 137.5 mg/L. Impurities such as Fe, Al, and Si were not detected, as the pH increased to 7.5 over time and these impurities were precipitated and removed.

TABLE 11

| time (min) | Mg | Ca | Fe | Na | K | Al | Si | pH |
|---|---|---|---|---|---|---|---|---|
| 5 | 48900 | 160.2 | 88 | 18.7 | 7.2 | 0 | 200 | 6.01 |
| 10 | 49300 | 173.2 | 37 | 15.9 | 6.8 | 0 | 220 | 6.2 |
| 15 | 50900 | 159.6 | 0 | 16.4 | 7.9 | 0 | 90.6 | 6.84 |
| 30 | 51000 | 160.6 | 0 | 17.7 | 7.7 | 0 | 34 | 6.94 |
| 45 | 51100 | 136.6 | 0 | 16.1 | 5.9 | 0 | 11 | 7.2 |
| 60 | 52300 | 132.2 | 0 | 15.4 | 6.1 | 0 | 0 | 7.3 |
| 90 | 53400 | 138.2 | 0 | 15.4 | 6.6 | 0 | 0 | 7.5 |
| 120 | 53400 | 137.5 | 0 | 16.3 | 6.4 | 0 | 0 | 7.4 |

Table 12 shows the measurement results of the composition (mg/L) of the second-stage leachate in the impurity purification leaching process using a solid-to-liquid ratio of 15% (500 mL of solution/75 g of sample). In this case, magnesium (Mg) was leached up to 56200 mg/L, and calcium (Ca) was leached up to 117.5 mg/L. In addition, iron (Fe), aluminum (Al), and silicon (Si) were not detected, as they were completely precipitated due to the increase in pH from 7.11 at the beginning of the reaction to 7.94 after 30 minutes.

TABLE 12

| time (min) | Mg | Ca | Fe | Na | K | Al | Si | pH |
|---|---|---|---|---|---|---|---|---|
| 5 | 51900 | 190.2 | 19 | 21 | 5.2 | 0 | 20 | 7.11 |
| 10 | 52300 | 183 | 0 | 22.2 | 4.4 | 0 | 6 | 7.32 |
| 15 | 52900 | 171.6 | 0 | 19.8 | 5.6 | 0 | 2 | 7.54 |
| 30 | 53000 | 160.6 | 0 | 19.7 | 5.7 | 0 | 0 | 7.94 |
| 45 | 56100 | 144.6 | 0 | 21 | 6.9 | 0 | 0 | 8.02 |
| 60 | 56200 | 112.2 | 0 | 20.1 | 7.4 | 0 | 0 | 8.13 |
| 90 | 56400 | 118.2 | 0 | 21.5 | 8.6 | 0 | 0 | 8.15 |
| 120 | 56200 | 117.5 | 0 | 19.4 | 6.4 | 0 | 0 | 8.1 |

### Exemplary Embodiment 4: Preparation of Mg-Containing Powder Through Vacuum Distillation Process

A second-stage leachate with an adjusted pH was obtained through the impurity purification process, and the leachates were subjected to vacuum distillation to obtain a solution and a powder containing magnesium (Mg).

The vacuum distillation experiment was carried out at a vapor temperature of 45° C. or higher and a stirring speed of 25 RPM or higher for 1 hour. The distilled solution that was recovered during this process was reused for the preparation of sulfuric acid.

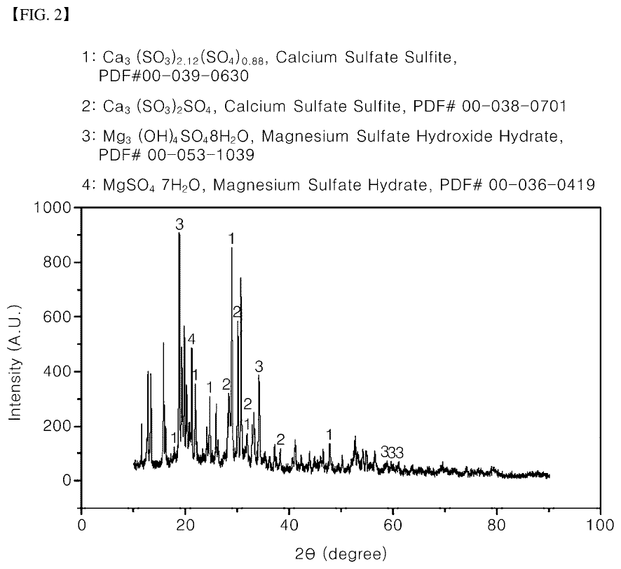

FIG. 2 shows the results of XRD analysis of the powder obtained after vacuum distillation. The main peaks corresponded to CaSO₄-based, MgSO₄-based, and Mg(OH)₄SO₄-based compounds. This indicates that impurities such as Fe, Si, and Al were completely removed by the impurity purification process, and only Mg and Ca remained in the powder.

### Exemplary Embodiment 5: Production of High-Purity MgO by Heat Treatment Process

The powder obtained after vacuum distillation was heat-treated at a temperature ranging from 1000° C. to 1500° C. The heat treatment was carried out using a box furnace under an air atmosphere for 30 minutes to 3 hours.

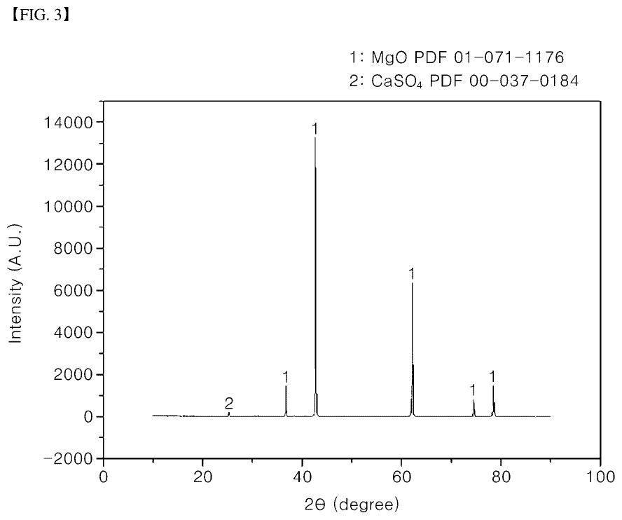

As a result, XRD analysis shown in FIG. 3 confirmed that the major peak of the powder heat-treated at 1200° C. or higher corresponded to MgO. The purity of the obtained MgO was calculated based on instrumental analysis using ICP.

According to the ICP analysis results shown in Table 13, calcium (Ca) was present at approximately 0.61 wt %. The presence of Ca in the powder was also confirmed by XRD analysis, where Ca appeared as a minor peak in the form of CaSO₄. The purity of the produced MgO was calculated to be 97.8%.

TABLE 13

| Oxide | MgO | CaSO₄ | Fe₂O₃ | Na₂O | K₂O | Al₂O₃ | SiO₂ |
|---|---|---|---|---|---|---|---|
| wt. % | 97.84 | 2.07 | N.D | 0.005 | 0.001 | 0.07 | 0.015 |

### Exemplary Embodiment 6: Purification of MgO by Washing with Distilled Water

To increase the purity of the produced MgO, a washing experiment was conducted to remove calcium (Ca) using distilled water at various solid-to-liquid ratios. The experiment was performed at room temperature and completed within 30 minutes.

The results are shown in Table 14 below. Table 14 presents the washing results of MgO obtained by heat treatment at 1200° C. for 30 minutes. When washing was performed at a solid-to-liquid ratio of 1/10 (MgO: 3.1 g, distilled water: 31 mL), 2.57 g of the material was removed, indicating a material loss of 82.9%.

TABLE 14

| Mg | Ca | Fe | Na | K | Al | Si | pH | residues, g |
|---|---|---|---|---|---|---|---|---|
| 12390 | 284.5 | 0 | 3.5 | 1.1 | 0 | 0 | 9.6 | 0.53 |

Table 15 presents the results of the first washing process after obtaining MgO through heat treatment at temperatures ranging from 1200° C. to 1500° C. for 3 hours. When 3.1 g of MgO was washed with 31 mL of distilled water, the amount of material loss was less than 0.5 g in all cases. It was also confirmed that the amount of Mg loss decreased with increasing heat treatment temperature, with Mg concentrations in the washing solution measured at 59 mg/L, 46 mg/L, and 31 mg/L, respectively. Here, the pH values of the washing solution after washing varied according to the heat treatment temperature and were measured as pH 10.5, pH 11.2, and pH 11.6, respectively.

TABLE 15

| heat | | | | | | | | | |
|---|---|---|---|---|---|---|---|---|---|
| treatment | | | | | | | | | |
| temperature | Mg | Ca | Fe | Na | K | Al | Si | pH | residues, g |
| 1200 | 59 | 235.3 | 0 | 4.1 | 1.2 | 0 | 0 | 10.5 | 2.95 |
| 1400 | 46 | 280 | 0 | 4.2 | 1.1 | 0 | 0 | 11.2 | 3.01 |
| 1500 | 31 | 280 | 0 | 4.5 | 1.1 | 0 | 0 | 11.6 | 3.05 |
| 1500 | 16 | 130 | 0 | 4.3 | 0.8 | 0 | 0 | 12.1 | 3.07 |
| solid-to- | | | | | | | | | |
| liquid ratio | | | | | | | | | |
| (1:2) | | | | | | | | | |

Tables 14 and 15 illustrate the material loss of the produced MgO and the amount of impurity removal according to heat treatment time and temperature. Specifically, it was confirmed that a heat treatment duration of at least 30 minutes is required to reduce Mg loss, and that performing the heat treatment at 1200° C. can further reduce the amount of Mg loss to a certain extent.

Accordingly, in order to produce and obtain high-purity MgO, a second washing was performed using samples heat-treated for 3 hours. Specifically, 3.1 g of MgO was washed with 31 mL of distilled water for 30 minutes at temperatures ranging from 1200° C. to 1500° C. The results are shown in Table 16 below.

As shown in Table 16, the amount of Mg loss slightly decreased as the heat treatment temperature increased, which was also supported by the pH measurements of the washing solution. Furthermore, the amount of Ca removed during the second washing was significantly greater than that of the first washing.

TABLE 16

| heat | | | | | | | | | |
|---|---|---|---|---|---|---|---|---|---|
| treatment | | | | | | | | | |
| temperature | Mg | Ca | Na | K | Fe | Al | Si | pH | residues, g |
| 1200 | 12 | 645 | 2 | 2 | N•D | N•D | N•D | 10.2 | 2.76 |
| 1400 | 4.5 | 642 | 0.17 | 1.2 | N•D | N•D | N•D | 11.1 | 2.94 |
| 1500 | 3 | 648 | 0.15 | 1.1 | N•D | N•D | N•D | 11.1 | 2.94 |

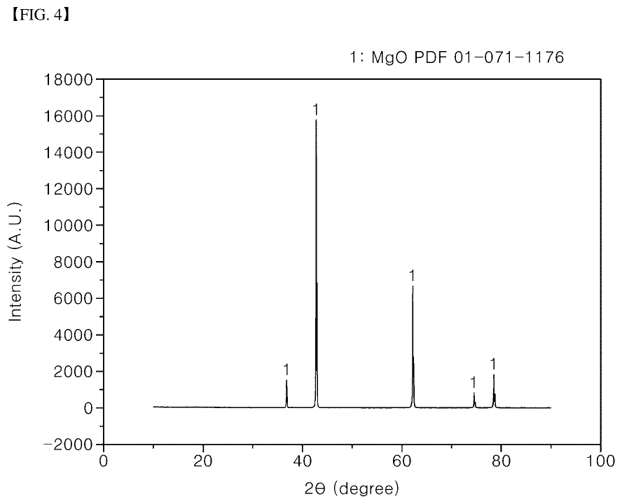

Table 17 shows the purity of MgO obtained after drying all of the twice-washed MgO at a temperature of 80° C. or higher, followed by ICP analysis and conversion to oxide (MgO) form. As shown in Table 17, the purity of the produced MgO was 99.76%, indicating that a highly pure MgO was successfully produced. In addition, the XRD analysis results of the produced MgO are shown in FIG. 4.

TABLE 17

| | Element | | | | | | |
|---|---|---|---|---|---|---|---|
| | Mg | Ca | Na | K | Fe | Al | Si |
| % | 60> | 5.8 | 0.0029 | 0.0007 | 0 | 0.028 | 0.006 |

| | Oxide | | | | | | |
|---|---|---|---|---|---|---|---|
| | MgO | CaSO₄ | Na₂O | K₂O | Fe₂O₃ | Al₂O₃ | SiO₂ |
| % | 99.76 | 0.17 | 0.005 | 0.0008 | 0 | 0.053 | 0.013 |

### INDUSTRIAL APPLICABILITY

The method for producing high-purity magnesium oxide from waste refractory material according to the present disclosure enables the environmentally friendly production of high-purity magnesium oxide (MgO), in which impurities such as Fe, Al, Si, and Ca are controlled, by applying an eco-friendly hydrometallurgical application process to waste refractories that have conventionally been recycled as secondary resources or disposed of by landfilling.

1. A method for producing high-purity magnesium oxide from a waste refractory material through an eco-friendly hydrometallurgical application process, comprising:
a step (S10) of subjecting a magnesium-containing waste refractory material to leaching and separating a leachate and residues through solid-liquid separation;
a step (S20) of impurity purification and leaching of the leachate;
a step (S30) of powdering the leachate subjected to the impurity purification and leaching step to prepare a magnesium-containing powder;
a step (S40) of heat-treating the magnesium-containing powder to prepare magnesium oxide; and
a step (S50) of washing the heat-treated magnesium oxide to obtain high-purity magnesium oxide,
wherein a purity of the washed magnesium oxide is 99% or higher.

2. The method of claim 1,
wherein the magnesium-containing waste refractory material contains magnesium in an amount ranging from 30 wt % to 55 wt %.

3. The method of claim 1, further comprising:
prior to step (S10) of subjecting a magnesium-containing waste refractory material to leaching and separating a leachate and residues through solid-liquid separation, a step of crushing or grinding the magnesium-containing waste refractory material.

4. The method of claim 3,
wherein the crushed or ground magnesium-containing waste refractory material has an average particle size of 100 mesh or less.

5. The method of claim 1,
wherein, in step (S10), the magnesium-containing waste refractory material is leached using a sulfuric acid solution having a molar concentration ranging from 1 M to 7 M.

6. The method of claim 5,
wherein step (S10) is performed under conditions in which:
a solid (g) to liquid (mL) ratio of the magnesium-containing waste refractory material to the sulfuric acid solution is from 1/10 to 3/10;
a reaction temperature is 100° C. or lower; and
a stirring speed is from 100 to 400 RPM.

7. The method of claim 1,
wherein in step (S20), the leachate obtained in step S10 is used as a leaching agent, and the leaching is carried out by introducing the magnesium-containing waste refractory material into the leaching agent, followed by separating the resulting leachate and residues.

8. The method of claim 7,
wherein, in step (S20), a process is repeatedly performed in which a preceding-stage leachate is used as a leaching agent, the magnesium-containing waste refractory material is introduced into the leaching agent for leaching, and a subsequent-stage leachate and residues are separated.

9. The method of claim 8,
wherein step (S20) is performed under conditions in which:
a solid (g) to liquid (mL) ratio of the magnesium-containing waste refractory material to the leaching agent is from 5 to 30;
a reaction temperature is 100° C. or lower; and
a stirring speed is from 100 to 400 RPM.

10. The method of claim 1,
wherein, in step (S20), the pH of the leachate subjected to the impurity purification and leaching step is 7 or higher.

11. The method of claim 1,
wherein step (S30) is performed for 30 minutes to 2 hours under conditions in which:
a vapor temperature is 45° C. or higher; and
a stirring speed is 25 RPM or higher.

12. The method of claim 1,
wherein, in step (S40), the heat treatment is performed at a temperature of 1000° C. to 1500° C. for 30 minutes to 6 hours.

13. The method of claim 12,
wherein, in step (S40), the heat treatment is performed at a temperature of 1200° C. to 1500° C. for 3 hours to 6 hours.

14. The method of claim 1,
wherein at least one of residues generated in step (S20), a distillate generated in step (S30), exhaust gas components generated in step (S40), or a combination thereof, is reused in step (S10).

15. The method of claim 1,
wherein, in step (S50), the heat-treated magnesium oxide is washed with distilled water for 5 minutes to 50 minutes, under conditions in which:
a solid (g) to liquid (mL) ratio of the heat-treated magnesium oxide to the distilled water is from 1/1 to 1/10; and
a temperature is from 20° C. to 50° C.

16. The method of claim 1,
wherein step (S50) is performed once or repeatedly performed 2 to 5 times.

17. The method of claim 1,
wherein, in step (S40), the heat treatment is performed at a temperature of 1200° C. to 1500° C. for 3 hours to 6 hours, and
wherein step (S50) is repeatedly performed 2 to 5 times.

18. A magnesium oxide produced according to the method of claim 1.
